(19) United States
(12) Patent Application Publication
(10) Pub. No.: US 2001/0021609 A1
(43) Pub. Date: Sep. 13, 2001

(54) Battery connector

(76) Inventor: Chun-Hsiang Chiang, Taipei Hsien (TW)

Correspondence Address: Stephen Z. Weiss, MOLEX INCORPORATED, 2222 Wellington Court, Lisle, IL, 60532, US

(21) Appl. No.: 09/799,308

(22) Filed: Mar. 5, 2001

(30) Foreign Application Priority Data
Mar. 3, 2000 (TW) 89203390

(51) Int. Cl. H01R 13/10; H01R 33/00

(52) U.S. Cl. 439/682

(57) ABSTRACT

A battery connector is provided, which includes an insulation housing having at least one terminal receiving groove, and at least one conductive terminal disposed in the one terminal receiving groove, the terminal including a body, a connecting portion that extends from one side of the body and is electrically connectable with a circuit board and a mating portion which extends from the other side of the body. The mating portion includes a first support arm and a second support arm. The first support arm has a first contact portion. The second support arm, parallel to the first support arm, has a second contact portion. The first and second contact portions are directed toward the opposed contact arms and are staggered from each other. The first and second contact portions achieve electrical contact with a mating blade terminal inserted therebetween, thereby increasing normal contact force of the conductive terminal contact.

### FIELD OF THE INVENTION

Reference is made to FIG. 1, which is a schematic view of a conventional battery connector. This includes a plug connector 1 and a socket connector 2 for mating with the plug connector 1. The plug connector 1 is generally secured to a circuit board of an electrical device (such as the mother board of a notebook computer). The socket connector 2 is provided at an output end of a battery. The plug connector 1 has a plurality of juxtaposed metal blade terminals 11. The socket connector 2 is provided with a plurality of insert slots 21 corresponding to the metal blade terminals 11. The insert slots 21 are defined by a plurality juxtaposed spacer walls 22 that are spaced apart from each other. Each of the insert slots 21 has a clamping terminal 23 disposed therein. Each clamping terminal 23 includes an inverted U-shaped base 231, a solder tail 232 that extends away from a bottom face of the inverted U-shaped base 231, and two clamping plates 233 extending respectively and upwardly from both sides of the inverted U-shaped seat 231 at opposite positions. The two clamping plates 233 are respectively provided with semi-circular projections 234 at an inner side thereof and opposed to one another. Each clamping terminal 23 is inserted into the corresponding insert slot 21 via a lower end of the socket connector 2.

With reference to FIG. 2, when the plug connector and the socket connector 2 are coupled to transmit electrical power signals, the clamping plates 233 on both sides of the clamping terminal 23 of the socket connector 2 clamp the metal blade terminal 11 to conduct electricity Although these conventional battery connectors 1, 2 can permit flow of electric current between the circuit board and the battery, with further reference to FIG. 2, electrical contact between the two battery connectors 1, 2 is achieved by the use of the two clamping plates 233 of the clamping terminal 23 to clamp the metal blade terminals 11. Therefore, the two clamping plates 233 must have a sufficient normal contact force to contact and secure the metal blade terminals 11. The normal contact force of each clamping terminal 23 is produced by the elastic returning action of the two clamping plates. That is, when each metal blade terminal 11 is inserted between the two clamping plates 233, the two clamping plates 233 displace and then move back, due to the elastic returning action thereof, to contact the metal blade terminals 11.

With a greater amount of displacement of the clamping plates 233, the returning action will be greater and therefore the normal contact force of the terminal will also be increased. Since the two clamping plates 233 are opposite to each other, the greatest returning action of the clamping plates 233 can only begin at the point where the projections of the two clamping plates 233 come into contact with each other, as shown in FIG. 3, and can end a distance that is one-half of the width of the insert slot 21. If additional normal contact force is needed, the slot 21 would have to be increased in width.

This invention is directed to solving the problems by providing an improved retention terminal for a battery connector of the character described herein.

### SUMMARY OF THE INVENTION

The primary object of the present invention is provide a battery connector that enables to an electrically conductive terminal to have a greater normal contact force.

Another object of the present invention is to provide battery connector electrical contact that effectively prevents poor electrical contact.

The essential feature of the present invention resides in that two support arms of each conductive terminal are staggered to increase the amount of displacement of transverse arms, thereby increasing the normal contact conductive terminal and effectively preventing poor electrical contact.

Accordingly, in order to achieve the aforementioned objects, a battery connector of the present invention includes an insulation housing having at least one terminal receiving groove and at least one conductive terminal that is received in said at least one conductive terminal. Said at least one conductive terminal includes a body, a connecting portion, a first support arm and a second support arm. The body has a first side and a second side opposite to the first side. The connecting portion extends from the first side of the body in a direction distal to the second side and can achieve electrical connection with a circuit board. The first support arm extends from the second side in a direction distal to the first side. The first support arm has a first contact portion. The second support arm extends from the second side at a position different from that of the first support arm on the second side and in a direction distal to the first side. The second support arm has a second contact portion. The second support arm and the first support arm are staggered in said at least one terminal receiving groove a matching terminal can be inserted via free ends of the two support arms to achieve electrical contact with the first contact portion and the second contact portion.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is an exploded isometric view of a conventional battery connector system;

FIG. 2 shows the metal blade terminals and the clamping terminal of the conventionalconnector system of FIG. 1 mated with each other;

FIG. 3 shows the clamping terminal of the conventional socket connector;

FIG. 4 is a partially exploded isometric view of the preferred embodiment of the present invention;

FIG. 5 is a fragmentary sectional view of the connector of FIG. 4;

FIG. 6 is the same fragmentary sectional view of FIG. 5, but with a conductive terminal assembled thereto;

FIG. 7 is a perspective view showing the battery connectors of the present invention in a mating state;

FIG. 8 is a schematic view illustrating how a metal insert plate of a plug connector is inserted into a corresponding conductive terminal of a socket connector;

FIG. 9 shows the metal insert plate of the plug connector and the conductive terminal of the socket connector in a coupled state;

FIG. 10 is a perspective schematic view of the second preferred embodiment of a conductive terminal of a battery connector according to the present invention;

FIG. 11 is a perspective schematic view of the third preferred embodiment of a conductive terminal of a battery connector according to the present invention;

FIG. 12 is a schematic view illustrating how the metal insert plate of the plug connector is inserted into the conductive terminal of FIG. 11; and

FIG. 13 shows the metal blade terminal of the plug connector and the conductive terminal of FIG. 11 in a coupled state.

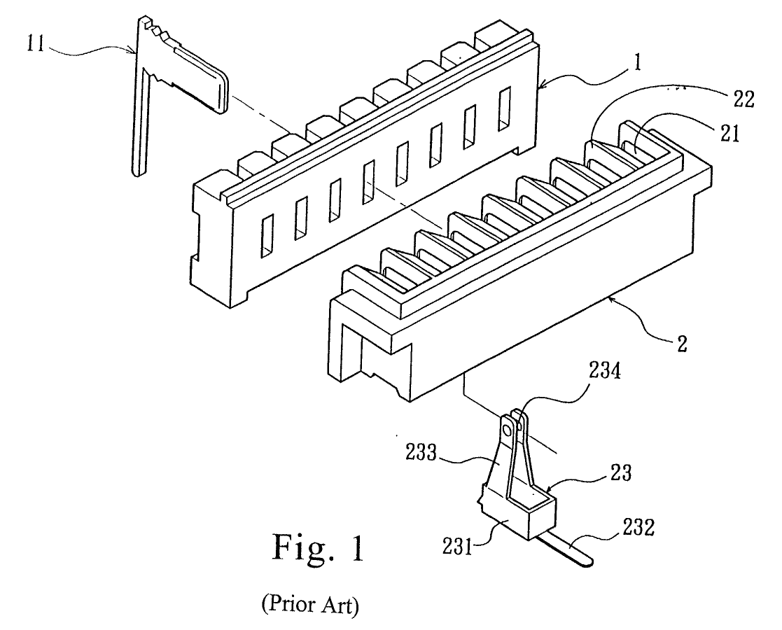

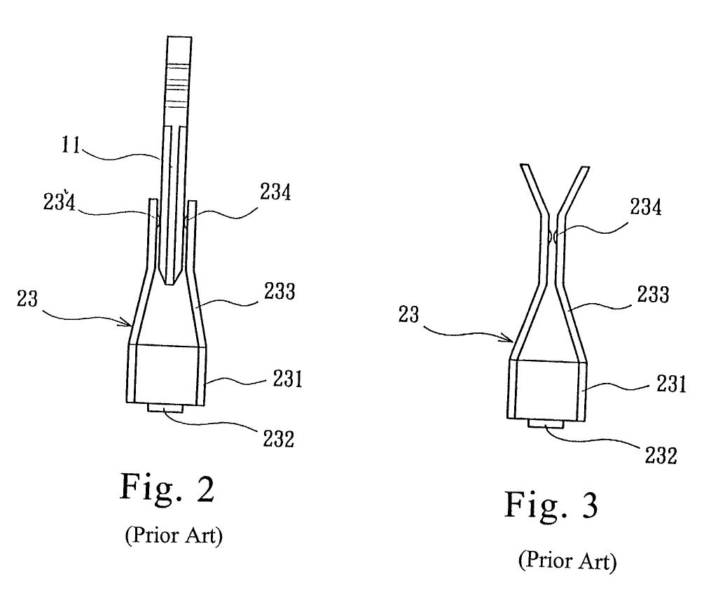

### DETAILED DESCRIPTION OF THE PREFERRED EMBODIMENT

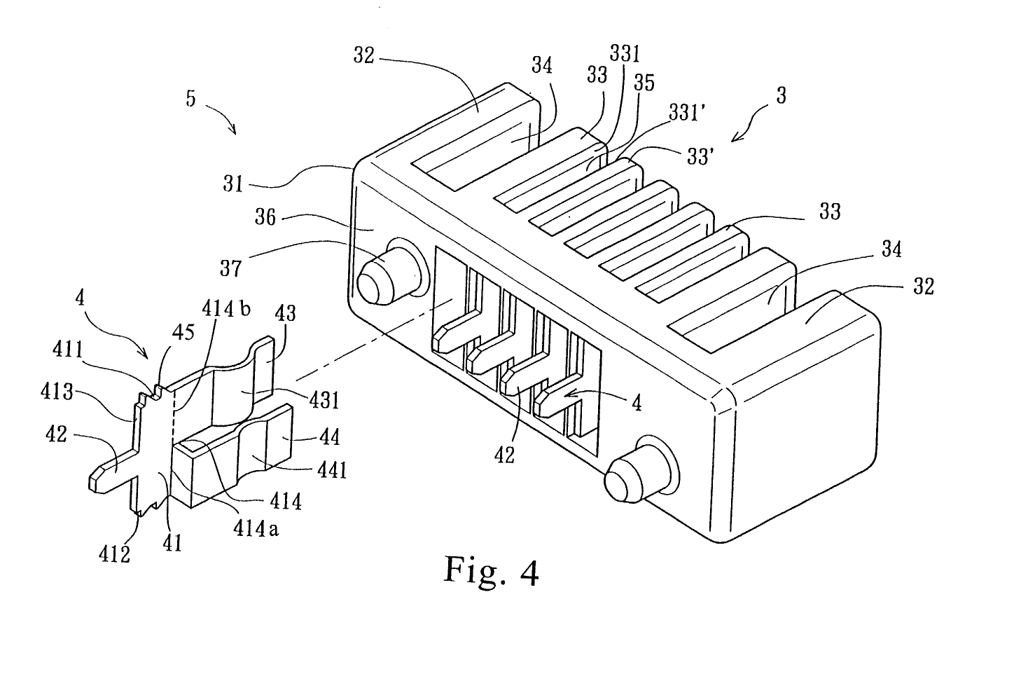

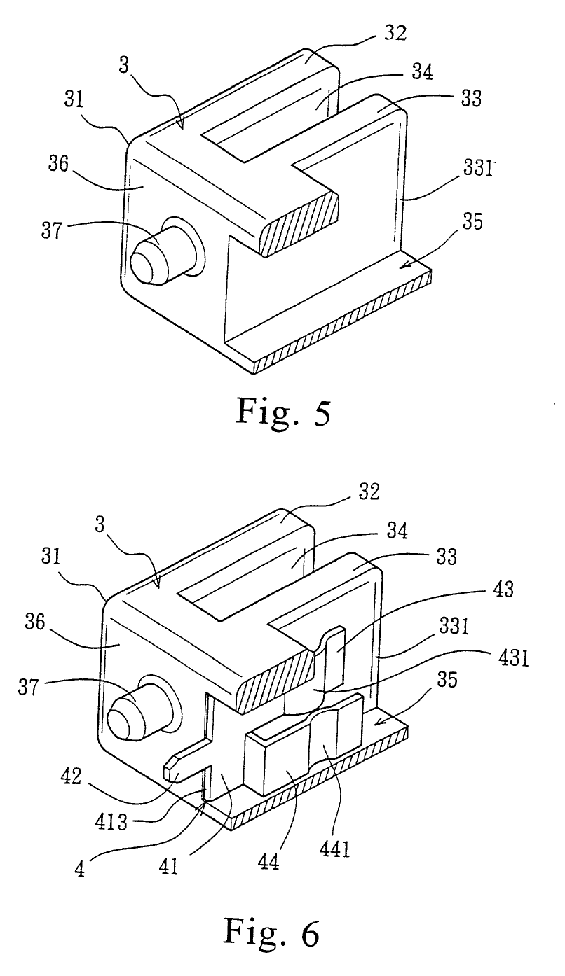

FIG. 4 is a partially exploded view of the embodiment of a battery the present invention. In the preferred embodiment, the battery connector 5 includes a socket insulation housing 3 and a plurality of conductive terminals 4. Two side plates 32 and a plurality of spacer plates 33 disposed between the two side plates 32 extend forwardly from the body 31 in a spaced-apart and juxtaposed arrangement such that a retaining groove 34 is defined between each side plate 32 and the adjacent spacer plate 33 for mating with and positioning another battery connector (i.e., a plug connector) during coupling of the battery connectors. As shown in FIG. 5, the insulation housing 3 further has a plurality of terminal receiving grooves 35. Each of the terminal receiving grooves 35 is a spacing defined by two adjacent spacer plates 33, 33′. The terminal receiving grooves 35 further extend to a mounting face 36 of the socket insulating housing 3. Both sides of the mounting face 36 of the housing 3 are respectively provided with positioning posts 37 projecting therefrom for positioning the battery connector 5 in predetermined circuit board engaging holes (not shown) during positioning of the circuit board.

Each conductive terminal 4 is received in the corresponding terminal receiving groove 35 of the socket insulation housing 3. Each conductive terminal 4 includes an upright body 41, a solder tail 42, a first support arm 43 and a second support arm 44 parallel to the first support arm 43. The body 41 is disposed in the terminal receiving groove 35 and has a top side 411, a bottom side 412 opposite to the top side 411, and a first side 413 and a second side 414 opposite to each other and disposed between the top and bottom sides 411, 412. The second side 414 may be divided into two end portions 414a, 414b. At least one of the top and bottom sides 411, 412 of the body 41 is provided with at least one retaining portion 45 that can abut against the walls of the terminal receiving groove 35 so as to achieve interference fit with the terminal receiving groove 35. In this embodiment, two retaining portions 44 are respectively disposed on the top and bottom sides 411, 412 of the body projecting block 41. Each retaining portion 45 is a projecting block. The solder tail 42 extends from a central position of the first side 413 of the body 41 in a direction opposite to the second side 414 for insertion into an insert hole (not shown) in the circuit board. The first support arm 43 extends from an upper end portion 414b of the second side 414 in a direction distal to the first side 413. The first support arm 43 has a first contact portion 431 that projects toward a wall surface 331′ of a right spacer plate 33′ of the terminal receiving groove 35 The second support arm 44 extends from a lower end portion 414a of the second side 414 of the body 41 in a direction perpendicular to the body 41. The arm 44 bends perpendicular to the lower end portion 414a and extends in a direction away from the first side 413. The second support arm 44 has a second contact portion 441 that projects toward a wall surface 331 of the left spacer plate 33 of the terminal receiving groove 35. By virtue of this arrangement, the first support arm 43 in the terminal receiving groove 35 is at a higher height than the second support arm 44 such that the first and second support arms 43, 44 are staggered in the terminal receiving groove 35. Accordingly, the second support arm 44 is farther away from the wall surface 331 of the left spacer plate 33 of the terminal receiving groove 35. Hence, a clearance is defined between free ends of the two support arms 43, 44 for insertion of a matching terminal of another battery connector(i.e., plug connector) thereinto to permit electrical contact with the first and second contact portions 431, 441 to thereby establish electrical connection between the two battery connectors. Furthermore, in this embodiment, each of the first and second contact portions 431, 441 is formed as a curved plane. The length of the first and second support anus 44 extending distal to the first side 413 is the same.

Based upon the aforesaid construction and relationship, during assembly, the conductive terminals 4 are respectively disposed in the terminal receiving grooves 35 exposed from the guide face 36 of the housing 3. After assembly, referring to FIG. 6, the retaining blocks 45 of the conductive terminals 4 will abut against the walls of the terminal receiving grooves 35 to position the conductive terminals 4 in the corresponding terminal receiving grooves 35 such that the connecting portions 42 project from the guide face 36 of the housing 3.

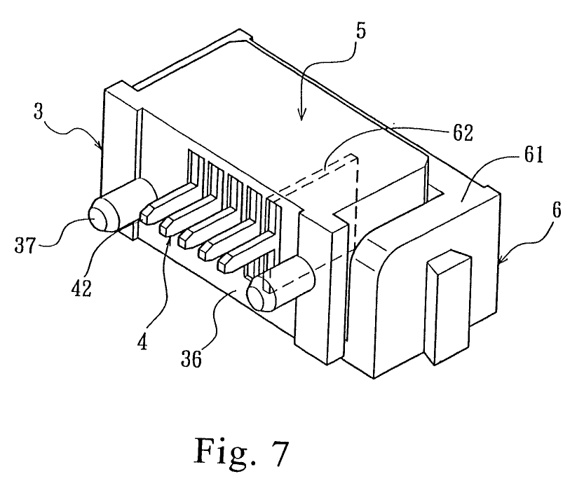

Reference is made to FIG. 7, which shows the coupling of the socket connector 5 according to this embodiment with a matching plug connector 6. The plug connector 6 includes a plug insulation housing 61 and a plurality of spaced-apart, juxtaposed metal blade terminal 62. As the present invention is not directed to the plug connector 6, and as the plug connector 6 is known in the art, a detailed description thereof is dispensed with herein. The coupling of the two battery connectors 5, 6, as well as the interaction between the terminals thereof, will be described in the following paragraphs.

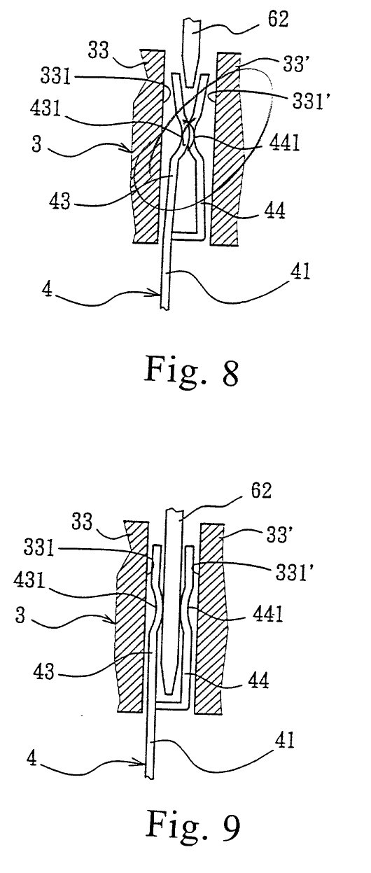

Referring to FIG. 8, when the plug connector 6 is coupled with the socket connector 5, each of the metal blade terminals 62 of the plug connector 6 is inserted into corresponding terminal receiving groove 35 and extends into the clearance between the free ends of the support arms 43, 44. The metal blade terminal 62 continues to advance and comes into contact with the first contact portion 431 and the second contact portion 441. In this embodiment, since the contact portions 431, 441 are configured to be curved planes, the metal blade terminal 62 is guided by the curved planes 431, 441, and can hence smoothly push away the contact portions 431, 441 and continue to advance into the fully inserted state shown in FIG. 9. When the first and second support arms 43, 44 are pushed away by the metal terminal blade 62 there occurs a displacement. Corresponding to such a displacement, a normal contact force is generated to urge the first and second contact portions 431, 441 to automatically spring back and to abut against the metal insert plate 62, thereby resulting in tight contact between the conductive terminal 4 and the metal blade terminal 62 to achieve interconnection between the two connectors 5, 6. In this embodiment, since the first and second arms 43, 44 are staggered, the first contact portion 431 of the first support arm 43 can contact the wall surface 331′ of the right spacer plate 33′ located in the contact terminal receiving groove 35, and the second contact portion 441 of the second support arm 44 can contact the wall surface 331 of the left spacer plate 33 located in the terminal receiving groove 35. As such, the amount of displacement of the two support arms 431, 432 can cover the width of the entire terminal receiving groove 35, which is greater than that achieved in the prior art, in which two clamping plates of the clamping terminals can at most displace one-half of the width of the insert slot. Therefore, the normal contact force of the conductive terminal according to the present invention is greater than that of the conventional clamping terminal and can permit stable electrical contact between the terminals 4, 61 of the two battery connectors 5, 6 to thereby effectively prevent poor electrical contact.

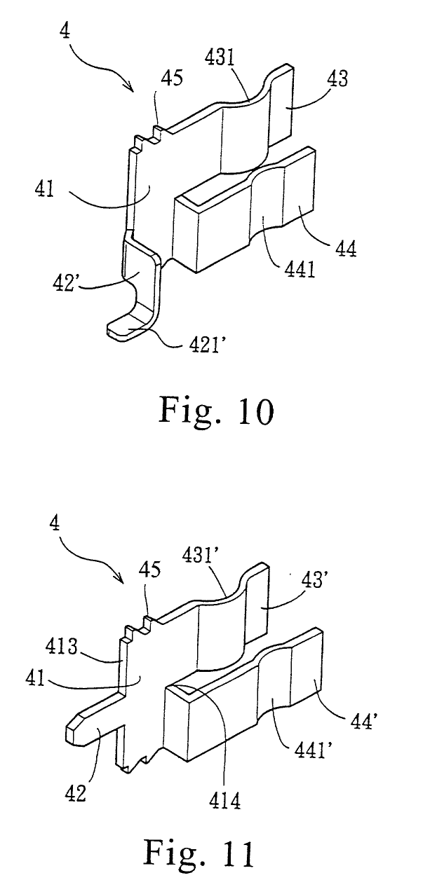

Furthermore, reference is made to FIG. 10, which illustrates the second preferred embodiment of the present invention. The difference between this preferred embodiment and the previous embodiment resides in the connecting portion 42′ of each of the conductive terminals 4. The connecting portion 42′ has a mounting face 421 that is parallel to a surface of the circuit board for adhering the mounting face 421′ on corresponding conductive points (not shown) of the circuit board via surface mount technique (SMT).

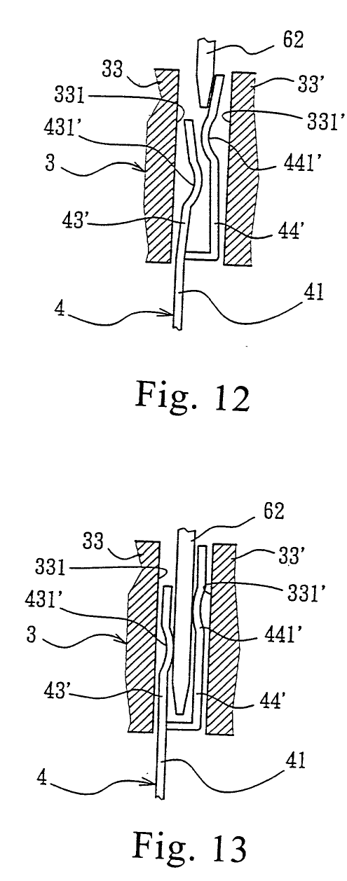

Finally, reference is made to FIG. 11, which shows the third preferred embodiment of this invention. The difference between this preferred embodiment and the previous embodiments resides in the length of the first and second support arm 43′, 44′ of each of the conductive terminals 4. In this embodiment, the length of the second support arm 44′ extending distal to the first side 413 is greater than the length of the first support arm 43′ extending in the same direction. Besides, the first contact portion 431 of the first support arm 43′, is closer to the guide face 36 than the second contact portion 441′ of the second support arm 44′. Hence, when the two battery connectors 5, 6 are coupled, the metal blade terminal 62 will, as shown in FIG. 12, be guided by the second contact portion 441′ and advance smoothly along the first contact portion 431 to the fully coupled state shown in FIG. 13. Due to the sequential guidance of the two contact portions 441′, 431′, the resistance during insertion in this embodiment will be smaller than in the conventional battery connector. As such, this embodiment further has the advantage of smooth insertion.

Accordingly, the present invention has the following advantages:

1. Conductive terminals have a greater normal contact force. Since the displacement of the support arms 43, 44 and 43′, 44′ of the conductive terminals 4 can cover the width of the entire terminal receiving grooves 35, which is much greater than that of the prior art, in which the two clamping plates of the clamping terminals can at most displace one-half of the width of the insert slot, and since the elastic returning force thus generated and is multiplied, then the normal contact force caused by the elastic returning force can be increased. Hence, the present invention has the advantage of increased normal contact force.

2. Effectively preventing poor electrical contact. As mentioned hereinabove, since the normal contact force of the conductive terminals 4 is comparatively large, during mating of the battery connectors 4, 6 the first and second contact portions 431, 441 are allowed to contact tightly the metal insert plates 62 to achieve stable electrical contact therebetween. Therefore, the present invention has the advantage of effectively preventing poor electrical contact.

It will be understood that the invention may be embodied in other specific forms without departing from the spirit or central characteristics thereof. The present examples and embodiments therefore are to be considered in all respects as illustrative and not restrictive, and the invention is not to be limited to the details given herein.

I claim:

1. A battery connector, comprising:
an insulation housing having at least one terminal receiving groove; and
at least one conductive terminal disposed in said at least one terminal receiving groove, said at least one conductive terminal including:
a body having a first side and a second side opposite to said first side;
a connecting portion that extends from said first side of said body in a direction away from said second side, the connecting portion designed to be electrically connected to a circuit board;
a first support arm having a first contact portion that extends from said second side in a direction away from said first side;
a second support arm parallel to the first support arm and extending from said second side at a lateral position different from that of the first support arm at said second side and in a direction away from said first side, said second support arm having a second contact portion, said second support arm and said first support arm being staggered in said at least one terminal receiving groove, a mating terminal being insertable between the first and second support arms so as to achieve electrical contact with said first contact portion and said second contact portion.

2. The battery connector according to claim 1, wherein said terminal receiving groove is formed by two spaced-apart, juxtaposed spacer plates, said two spacer plates defining said at least one terminal receiving groove therebetween.

3. The battery connector according to claim 1 wherein said insulation housing has a mating face, said at least one terminal receiving groove extending to said guide face, said connecting portion of said at least conductive terminal at said guide face being exposed from said insulation housing.

4. The battery connector according to claim 1 wherein said body of said at least one conductive terminal is provided with a plurality of retaining portions for abutting against walls of said at least one terminal receiving groove to thereby achieve interference with said at least one terminal receiving groove.

5. The battery connector according to claim 4, wherein each of said retaining portions is a projecting block.

6. The battery connector according to claim 1, wherein said first contact portion is formed by a curve defined by said first support arm, and said second contact portion is formed by a curve defined by said second support arm.

7. The battery connector according to claim 6, wherein said first support arm in said terminal receiving groove is at a higher height than said second support arm.

8. The battery connector according to claim 7, wherein said second support arm has a length greater than that of said first support arm.

9. The battery connector according to claim 7, wherein the first contact portion on the first support arm 19 is located a different distance along the first support arm from the second side of the body then the distance the second contact portion is located along the second support arm from the second side of the body.

10. The battery connector according to claim 1, wherein said connecting portion of said at least one conductive terminal has a mounting face that can be secured on said circuit board via surface mounting.
